(19) United States
(12) Patent Application Publication
(10) Pub. No.: US 2025/0382830 A1
(43) Pub. Date: Dec. 18, 2025

(54) DOOR LOCK DEVICE

(71) Applicant: MITSUI KINZOKU ACT CORPORATION, Yokohama-shi (JP)

(72) Inventors: Fuyuki NAKATSUKA, Kanagawa (JP); Takenobu KUROIWA, Kanagawa (JP); Takuya SHINOHARA, Kanagawa (JP)

(73) Assignee: MITSUI KINZOKU ACT CORPORATION, Yokohama-shi (JP)

(21) Appl. No.: 19/239,414

(22) Filed: Jun. 16, 2025

(30) Foreign Application Priority Data
Jun. 18, 2024 (JP) 2024-098247

(51) Int. Cl. E05B 81/18; E05B 81/06; E05B 81/30; E05B 81/36; E05B 83/00

(52) U.S. Cl. CPC E05B 81/18; E05B 81/06; E05B 81/30; E05B 81/36; E05B 83/00

(57) ABSTRACT

A door lock device includes: a latch that engages with a striker of a body of the vehicle, the latch rotatable about a latch axial direction orthogonal to an approach direction of the striker; a top cover that supports a latch shaft serving as a rotation center of the latch on an upper side in the latch axial direction; a lever latch integrally provided with the latch; and a pressing unit that is driven by a motor and rotates about a drive shaft in the approach direction of the striker. Further, the lever latch is positioned on a lower side with respect to the top cover in the latch axial direction, and the pressing unit presses and drives the lever latch on a lower side with respect to the top cover in the latch axial direction.

### CROSS-REFERENCE TO RELATED APPLICATION(S)

The present application claims priority to and incorporates by reference the entire contents of Japanese Patent Application No. 2024-098247 filed in Japan on Jun. 18, 2024.

### BACKGROUND

The present disclosure relates to a door lock device provided on a door of a vehicle.

There is known a door lock device that is provided on a back door of a vehicle and engages with a striker to moves a latch at a half latch position to a full latch position by an action of a motor (Japanese Patent No. 5828173).

### SUMMARY

There is a need for providing a further downsized door lock device.

According to an embodiment, a door lock device provided to a door of a vehicle, includes: a latch that engages with a striker of a body of the vehicle, the latch being rotatable about a latch axial direction orthogonal to an approach direction of the striker; a top cover that supports a latch shaft serving as a rotation center of the latch on an upper side in the latch axial direction; a lever latch integrally provided with the latch; and a pressing unit that is driven by a motor and rotates about a drive shaft in the approach direction of the striker. Further, the lever latch is positioned on a lower side with respect to the top cover in the latch axial direction, and the pressing unit presses and drives the lever latch on a lower side with respect to the top cover in the latch axial direction.

According to an embodiment, a door lock device provided to a door of a vehicle, includes: a latch that engages with a striker of a body of the vehicle, the latch being rotatable about a latch axial direction orthogonal to an approach direction of the striker, the latch having an engagement recess in the latch axial direction; a lever latch integrally provided with the latch; and a pressing unit that is driven by a motor and rotates about a drive shaft in the approach direction of the striker. Further, the lever latch includes: a lever portion whose distal end protrudes radially outward from an outer peripheral edge of the latch when viewed in the latch axial direction, the distal end being pressed and driven by the pressing unit; an engagement protrusion being fitted into the engagement recess; an annular portion to which the latch shaft is fitted; and a column portion extending in the latch axial direction, the column portion connecting the engagement protrusion and the lever portion.

### BRIEF DESCRIPTION OF THE DRAWINGS

FIG. 1 is a schematic cross-sectional view of a door lock device according to an embodiment of the present disclosure and a vehicle provided with the door lock device as viewed in a vehicle width direction;

FIG. 2 is a perspective view of the door lock device;

FIG. 3 is an exploded perspective view of the door lock device;

FIG. 4 is an exploded perspective view of a meshing unit;

FIG. 5 is an exploded perspective view of a latch, a lever latch, and a latch shaft;

FIG. 6 is a plan view of the latch and the lever latch when viewed from an R direction;

FIG. 7A is a diagram of a drive unit from which a cover is removed and a part of a mechanism of the meshing unit as viewed from the front, illustrating a state before a striker enters;

FIG. 7B is a diagram of a drive unit from which a cover is removed and a part of a mechanism of the meshing unit as viewed from the front, illustrating a full latch;

FIG. 8A is a diagram illustrating the operation of the meshing unit by the action of the pressing unit and illustrating a state before the striker enters a holding notch;

FIG. 8B is a diagram illustrating the operation of the meshing unit by the action of the pressing unit and illustrating a state in which the striker has entered the holding notch and entered a half latch state;

FIG. 8C is a diagram illustrating the operation of the meshing unit by the action of the pressing unit and illustrating a state in which the pressing unit starts to abut against a sliding contact surface of a lever portion;

FIG. 8D is a diagram illustrating the operation of the meshing unit by the action of the pressing unit and illustrating a full latch state; and

FIG. 9 is a perspective view of a meshing unit according to a modification.

### DETAILED DESCRIPTION

The door lock device of Japanese Patent No. 5828173 has a structure in which a drive pin of a sector gear that transmits output from the motor comes into contact with a latch pin of a latch and moves the latch to the full latch position. However, there are many restrictions on the layout due to the contact position between the drive pin protruding in a vehicle front-rear direction and a latch pin protruding in a vehicle up-down direction or operation ranges of the drive pin and the latch pin, and it is difficult to downsize by bringing the drive unit and a meshing unit close to each other.

Hereinafter, embodiments of a door lock device according to the present disclosure will be described in detail with reference to the drawings. Note that the present disclosure is not limited by the embodiments.

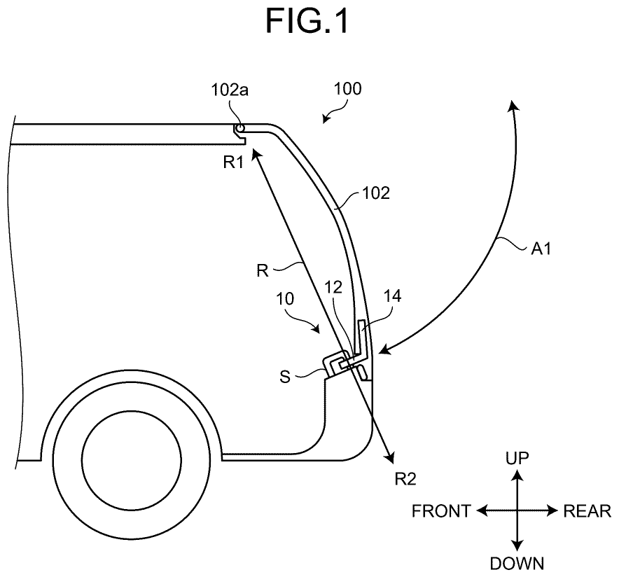

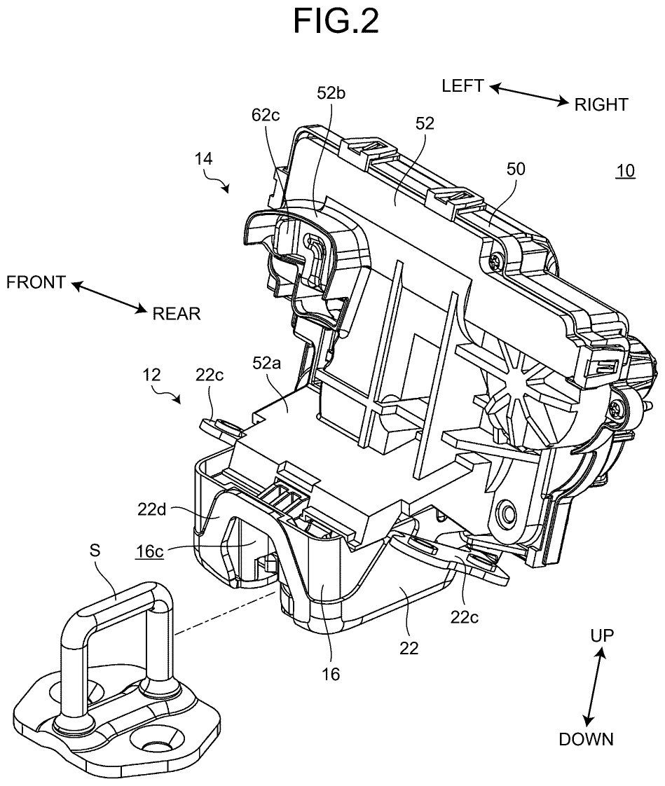

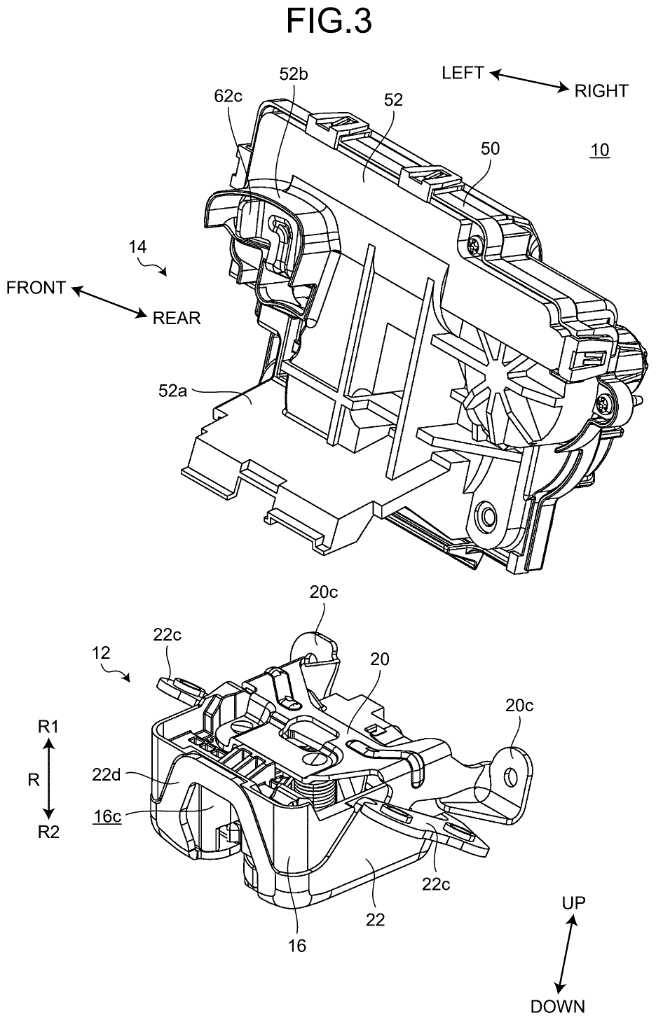

FIG. 1 is a schematic cross-sectional view of a door lock device 10 according to an embodiment of the present disclosure and a vehicle 100 provided with the door lock device 10 as viewed in a vehicle width direction. FIG. 2 is a perspective view of the door lock device 10. FIG. 3 is an exploded perspective view of the door lock device 10. The door lock device 10 is provided at the lower end of a back door 102 of the vehicle 100 such as a one-box car. The back door 102 opens and closes along an arc arrow A1 about a hinge 102a at the upper end. The back door 102 is, for example, a power back door.

The door lock device 10 has an obtuse L-shape as viewed in the vehicle width direction and includes a meshing unit 12 protruding forward or obliquely downward with respect to a L-shaped bent portion, and a drive unit 14 protruding upward or obliquely upward. The meshing unit 12 is a portion that engages with a striker S of the vehicle 100. The meshing unit 12 and the drive unit 14 may form an L shape that is not an obtuse angle. The meshing unit 12 corresponds to a short side portion of the L shape, and the drive unit 14 corresponds to a long side portion. That is, since the shape is as if the drive unit 14 is erected with respect to the meshing unit 12, the drive unit 14 has little influence on the dimension in the front-rear direction of the vehicle, and thus the dimension in the front-rear direction of the vehicle can be suppressed as a whole, whereby the vehicle layout property is improved. The meshing unit 12 is disposed substantially in a tangential direction of the arc arrow A1. The meshing unit 12 and the drive unit 14 each have a unit structure and can be separated (see FIG. 3); however, the two may be integrated.

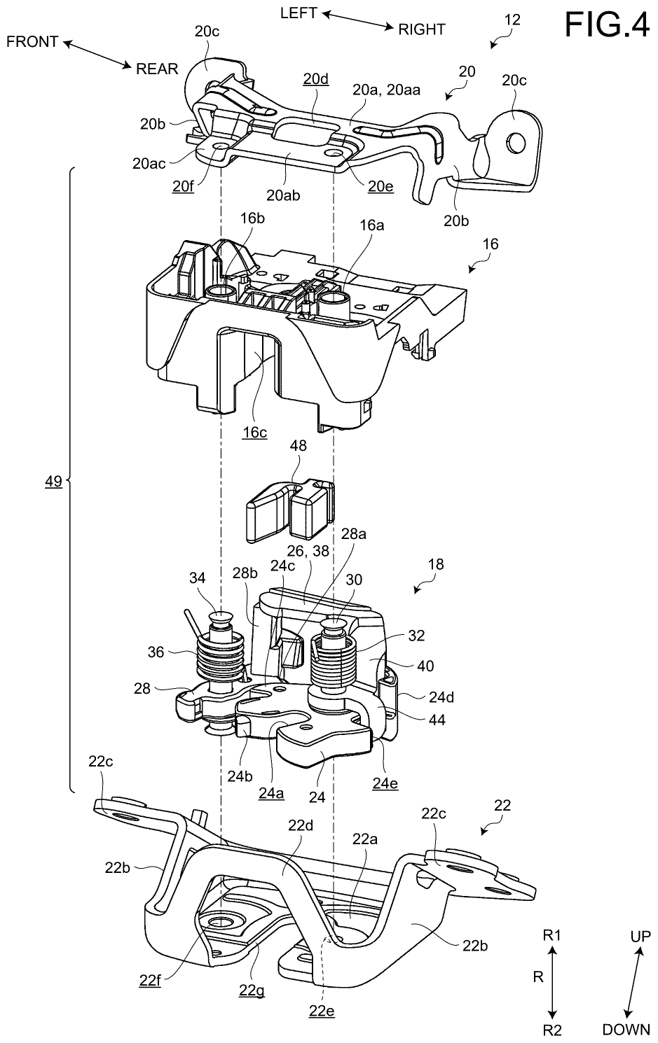

In the present application, in the description of the door lock device 10, directions are defined on the basis of a vehicle-mounted state as illustrated in FIG. 1, and in each of the drawings, the directions are indicated by arrows as appropriate. The left-right direction is also referred to as the vehicle width direction. Left and right are based on a state viewed from the front of the vehicle. In addition, although the mounted state of the door lock device 10 varies depending on the vehicle type, it is based on the premise that the drive unit 14 extends in the up-down direction for convenience of description. Furthermore, an extending direction of a latch shaft 30 (see FIG. 4) described later is defined as an R direction, an upper side in the R direction is defined as an R1 side, and a lower side in the R direction is defined as an R2 side. The R direction is a direction orthogonal to the relative approach direction of the striker S with respect to the door lock device 10 and is a direction, generally, from the meshing unit 12 toward the hinge 102a.

FIG. 4 is an exploded perspective view of the meshing unit 12. In the meshing unit 12, a meshing mechanism 18 is provided to a base member 16 formed by resin molding, an R1 side thereof is covered with a top plate 20, and an R2 side thereof is covered with a bottom plate 22. The top plate 20 and the bottom plate 22 are obtained by machining a metal plate.

The meshing mechanism 18 includes a latch 24 rotatable about the R direction and engages with the striker S, a lever latch 26 integrally provided on the R1 side of the latch 24, and a ratchet 28 rotatable about the R direction and holding the latch 24 in an engagement state with respect to the striker S.

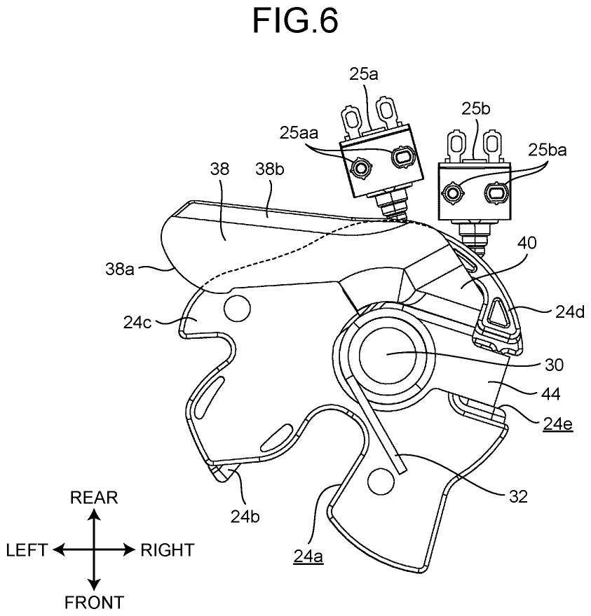

The latch 24 is pivotally supported by the latch shaft 30 as the rotation center and is elastically biased in the counterclockwise direction by a torsion spring 32 provided around the latch shaft 30. The latch 24 includes a holding notch 24a that holds the striker S, a full latch engagement portion 24b, a half latch engagement portion 24c, a cam 24d, and an engagement recess 24e. The full latch engagement portion 24b is a protrusion on a clockwise side surface of the holding notch 24a. The half latch engagement portion 24c is formed at a position slightly more clockwise with respect to the full latch engagement portion 24b. The cam 24d is formed at a position further clockwise with respect to the half latch engagement portion 24c. The cam 24d is an arc-shaped wall and operates switches 25a and 25b (see FIG. 6).

The switches 25a and 25b are provided behind the latch 24 for the convenience of layout and cable routing. The cam 24d is inevitably provided on the side opposite to the holding notch 24a for reasons that it is necessary to provide the cam 24d at a position avoiding the holding notch 24a, the full latch engagement portion 24b, and the half latch engagement portion 24c and that it is necessary to face the switches 25a and 25b from perspectives of the function.

The engagement recess 24e is a portion into which an engagement protrusion 44 described later is fitted in the R2 direction and engaged. The engagement recess 24e of the present embodiment is a rectangular notch formed in the outer peripheral edge of the latch 24; however, the engagement recess 24e may have a hole shape or the like as long as it is recessed in the R2 direction.

The ratchet 28 is pivotally supported by a ratchet shaft 34 as a rotation center and is elastically biased in the clockwise direction by a torsion spring 36 provided around the ratchet shaft 34. The ratchet 28 includes an engagement claw 28a and a ratchet pole 28b. The ratchet pole 28b is provided between the ratchet shaft 34 and the engagement claw 28a and is erected toward the R1 side. The latch shaft 30 and the ratchet shaft 34 are axes extending in the R direction.

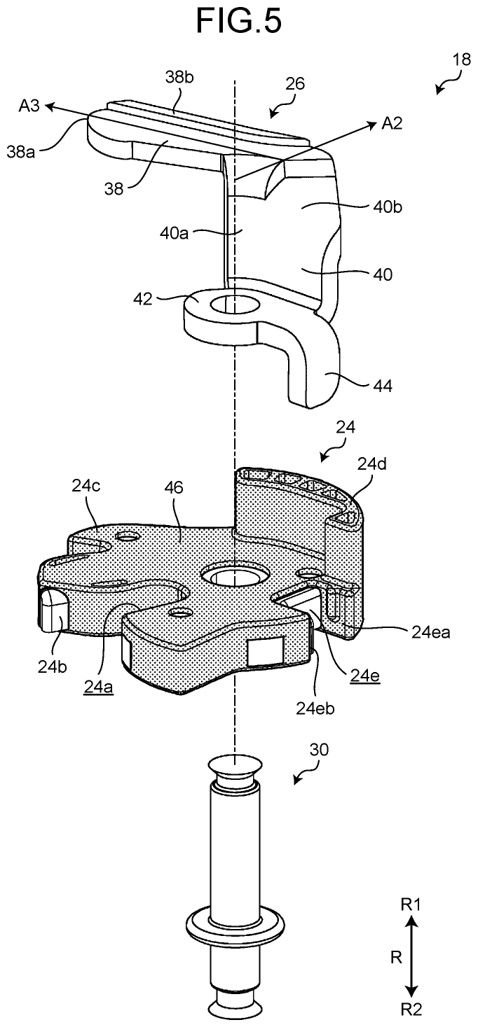

FIG. 5 is an exploded perspective view of the latch 24, the lever latch 26, and the latch shaft 30. FIG. 6 is a plan view of the latch 24 and the lever latch 26 as viewed in the R direction. The lever latch 26 is a metal material and includes a lever portion 38, a column portion 40, an annular portion 42, and an engagement protrusion 44. The annular portion 42 is a portion to which the latch shaft 30 is fitted and abuts on an R1 side surface of the latch 24. The lever portion 38 extends along a plane orthogonal to the R direction at a position shifted from the latch shaft 30. In the present embodiment, the lever portion 38 extends in a direction A3 substantially orthogonal to a radial direction A2 with reference to the latch 24, but it is not limited thereto.

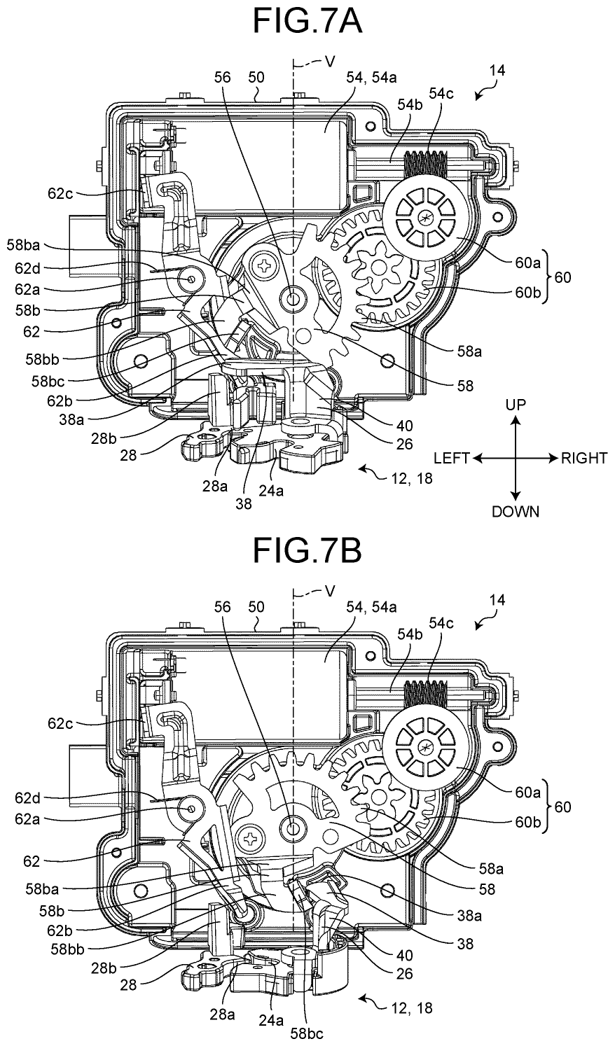

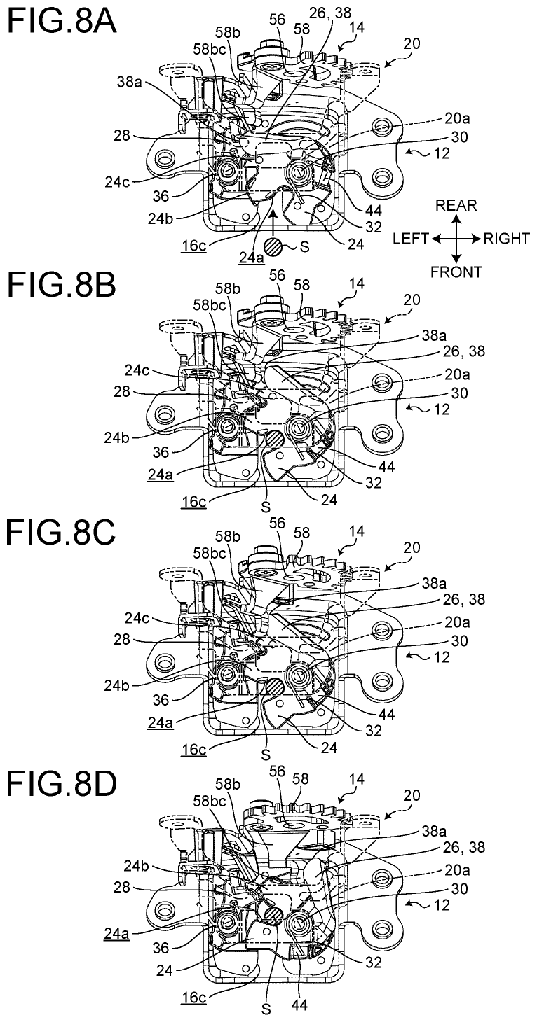

In a state where the striker S has not entered the door lock device 10 (see FIG. 8A), the lever portion 38 extends substantially in the vehicle width direction. The lever portion 38 is slightly widened as it extends in the A3 direction, an arc-shaped sliding contact surface 38a is formed from the distal end to a surface on the inner diameter side with reference to the latch 24, and a ridge 38b slightly protruding toward the R1 side along an edge is formed on a side in the radial direction A2. The sliding contact surface 38a is a surface extending in the R direction and is pressed and driven in the vehicle width direction by a pressing unit 58bc (see FIGS. 7A and 7B) described later. The lever portion 38 is positioned on the R1 side with respect to the annular portion 42 and is positioned on the R2 side with respect to a top cover 20a.

The column portion 40 extends in the R1 direction and connects the peripheral edge of the annular portion 42, the engagement protrusion 44, and an end of the lever portion 38. That is, the lever portion 38 is disposed at a position slightly shifted toward the R1 side from the latch 24 by the column portion 40. Although the column portion 40 has a plate shape, a curved portion 40a extending in such a manner as to extend along the outer curved surface of the annular portion 42 is formed on the A3 side, and an oblique curved portion 40b is formed near R2 on the opposite side of A3 to have high strength, and thus the column portion is hardly bent in any direction. The column portion 40 may have a cylindrical shape or the like in which the latch shaft 30 is fitted integrally with the annular portion 42.

The engagement protrusion 44 is constituted by a plate piece extending from the annular portion 42 and bent in the R2 direction. The engagement protrusion 44 fits in the engagement recess 24e without a gap. With the latch shaft 30 fitted to the annular portion 42 and the engagement protrusion 44 engaged with the engagement recess 24e, the lever latch 26 becomes non-rotatable relatively to the latch 24 and becomes substantially integrated. Although fastening means such as a screw is not necessary for this integration, a fastening means may be used in combination as necessary.

The latch 24 is covered with a thin resin mold 46 over an area indicated by dots in FIG. 5. The resin mold 46 covers a counterclockwise surface 24ea in the engagement recess 24e but exposes the metal material on a clockwise surface 24eb. The metal material is exposed at the distal end of the full latch engagement portion 24b. The resin mold 46 is a resin material having some elasticity. The engagement protrusion 44 is lightly press-fitted into the engagement recess 24e in such a manner as to slightly compress the resin mold 46 and thus does not rattle. Meanwhile, the engagement protrusion 44 drives the latch 24 in the clockwise direction during a retracting operation of the striker S, and thus the engagement protrusion 44 and the clockwise surface 24eb of the engagement recess 24e are in contact with each other on the metal surfaces, whereby the driving force can be reliably transmitted and the durability is increased.

As illustrated in FIG. 6, in the lever portion 38, the sliding contact surface 38a at the distal end protrudes radially outward with respect to the outer peripheral edge of the latch 24 when viewed in the R direction. Therefore, the lever portion 38 is away from the latch shaft 30 to some extent and can increase the moment for rotating the latch 24, and thus, accordingly, it is possible to reduce the driving force by the pressing unit 58bc.

Since the lever portion 38 receives an action from the pressing unit 58bc, it is desirable to provide the lever portion 38 on a substantially opposite side of the holding notch 24a of the latch 24. However, since the cam 24d and the switches 25a and 25b are provided, the lever portion 38 cannot directly protrude radially outward from the R1 side surface of the latch 24. Therefore, in the present embodiment, the lever portion 38 is disposed at a position slightly shifted toward the R1 side with respect to the latch 24 by the column portion 40 and does not interfere with the cam 24d of an arc-shaped wall or support posts 25aa or 25ba of the switches 25a or 25b, respectively, protruding in the R1 direction. In addition, this gives freedom of layout to a space between the lever portion 38 and the latch 24, and a rubber piece 48 (see FIG. 4) can be disposed. Note that the height of the lever latch 26 is appropriately limited and is set to be on the R2 side with respect to the top cover 20a as described above.

The column portion 40 does not directly receive a force from the pressing unit like a pin protruding in the R1 direction does in Japanese Patent No. 5828173 but receives a moment via the lever portion 38. In general, it is desirable that a driving side and a driven side are connected at two or more points appropriately separated from each other for transmission of a moment. The engagement recess 24e with which the engagement protrusion 44 is engaged is located at the outer peripheral edge of the latch 24 and is appropriately separated from the latch shaft 30, and the column portion 40 reliably transmits the moment by the lever portion 38 to the latch 24 at two places of the annular portion 42 and the engagement protrusion 44.

The lever latch 26 is axially aligned with the latch 24 by the annular portion 42 and is angularly positioned by the engagement protrusion 44. Since the lever portion 38 extends along a plane orthogonal to the R direction, the pressing unit 58bc presses the lever portion 38 in the plate thickness direction and has higher strength than a pin protruding in the R direction as in Japanese Patent No. 5828173.

Referring back to FIG. 4. The base member 16 has shaft cylinders 16a and 16b into which the latch shaft 30 and the ratchet shaft 34 are inserted, respectively, and an approach groove 16c of the striker S. The rubber piece 48 for shock absorption is provided between the latch shaft 30 and the ratchet shaft 34. The rubber piece 48 is fixed to the base member 16.

The top plate 20 includes the top cover 20a that covers a part or the entirety of the base member 16 on the R1 side, side covers 20b that cover a part or the entirety of sides, and fixing pieces 20c included at both ends in the vehicle width direction. Both ends of the top cover 20a in the vehicle width direction are connected to the side covers 20b via slightly inclined portions. A fixing piece 20c forms a plane extending in a substantially up-down direction and the vehicle width direction, has a bolt hole formed at the center, and is fastened together with a case 50 and a cover 52 described later.

The top cover 20a has a first flat plate portion 20aa close to the rear side, and a second flat plate portion 20ab and a third flat plate portion 20ac close to the front side. The third flat plate portion 20ac has a slightly narrow area close to the left side, and the second flat plate portion 20ab is a portion on the right side of the third flat plate portion 20ac. A boundary between the first flat plate portion 20aa, the second flat plate portion 20ab, and the third flat plate portion 20ac has a step shape. The first flat plate portion 20aa is slightly closer to the R1 side than the second flat plate portion 20ab is, and the third flat plate portion 20ac is slightly closer to the R2 side than the second flat plate portion 20ab is. A slightly longitudinal exposure hole 20d is formed between the first flat plate portion 20aa and the second flat plate portion 20ab.

A latch shaft hole 20e into which an upper portion of the latch shaft 30 is inserted is formed in the second flat plate portion 20ab. A ratchet shaft hole 20f into which an upper portion of the ratchet shaft 34 is inserted is formed in the third flat plate portion 20ac. The latch shaft hole 20e and the ratchet shaft hole 20f support the latch shaft 30 and the ratchet shaft 34, respectively. This support means is fixing by caulking; however, supporting by a shaft or the like may be employed.

The bottom plate 22 includes a bottom cover 22a that covers a part or the entirety of the base member 16 on the R2 side, side covers 22b that cover a part or the entirety of sides, fixing pieces 20c included at both ends in the vehicle width direction, and a guard arch 22d. The side cover 22b and the side cover 20b may partially overlap.

Both ends of the bottom cover 22a are connected to the side covers 22b. A side cover 22b has a triangular shape, and a rear inclined side is connected to a fixing piece 22c. A fixing piece 22c has a plane extending substantially in the front-rear direction and the vehicle width direction, has one or more bolt holes, and is fixed to the lower end of the back door 102. The guard arch 22d has an arch shape whose both ends are connected to the ends of the bottom cover 22a and the side cover 22b and surrounds the approach groove 16c of the striker S.

In the bottom cover 22a, a latch shaft hole 22e into which the lower portion of the latch shaft 30 is inserted, a ratchet shaft hole 22f into which the lower portion of the ratchet shaft 34 is inserted, and a notch 22g corresponding to the approach groove 16c are formed. The latch shaft hole 22e and the ratchet shaft hole 22f support the latch shaft 30 and the ratchet shaft 34, respectively. This support means is fixing by caulking; however, supporting by a shaft or the like may be employed. In this manner, the meshing mechanism 18 including the latch 24, the ratchet 28, and the lever latch 26 is disposed in a meshing mechanism area 49 on the R2 side with respect to the top cover 20a and on the R1 side with respect to the bottom cover 22a. In particular, the lever latch 26 is relatively low and is limited to the R2 side with respect to the top cover 20a. Both upper and lower ends of the latch shaft 30 and the ratchet shaft 34 are supported by the top cover 20a and the bottom cover 22a, whereby the strength at the time of retraction of the striker S can be secured.

The drive unit 14 will be described with reference to FIGS. 2, 3, 7A, and 7B. FIGS. 7A and 7B are diagrams of the drive unit 14 from which the cover 52 is removed and the meshing mechanism 18 as viewed from the front, in which FIG. 7A is a diagram illustrating a state before the striker S enters, and FIG. 7B is a diagram illustrating a full latch state. In the drive unit 14, various mechanisms are provided in the case (resin housing) 50 on the rear side, and the front side is covered with the cover (resin housing) 52. The cover 52 also covers a part of the meshing unit 12. The lower end of the cover 52 forms a projecting portion 52a projecting forward and covers almost the entire top surface of the meshing unit 12. The projecting portion 52a covers at least upper portions of the switches 25a and 25b in the meshing unit 12 and can prevent water from reaching the switches 25a and 25b. The left side of the cover 52 exposes an emergency operation unit 62c described later, thereby enabling manual operation to left or right (including screwdriver operation or the like). In the portion where the emergency operation unit 62c is exposed, an eaves portion 52b is formed from an upper side to lateral sides, thereby preventing water from entering from the upper side. As described above, the drive unit 14 is covered with the case 50 and the cover 52 except for the exposed portion and the lower surface of the emergency operation unit 62c, whereby it is made possible to prevent water from entering internal electric components or the like. The case 50 and the cover 52 are made of a resin material and are lightweight.

As illustrated in FIGS. 7A and 7B, the drive unit 14 includes a motor 54 provided at an upper portion, a sector gear 58 rotatable about a drive shaft 56 substantially in the center, a deceleration mechanism 60, and a lever opener 62. The motor 54 is disposed sideways and has a cylindrical main body 54a and a rotation shaft 54b protruding rightward. The rotation shaft 54b is provided with a worm 54c. The drive shaft 56 is a shaft extending in the front-rear direction and is positioned slightly above the meshing unit 12. The sector gear 58 is driven to rotate about the drive shaft 56 by a motor 54 and includes teeth 58a formed over approximately 90 degrees and a pressing lever 58b on an opposite side of the teeth 58a. The pressing lever 58b includes a bent portion 58ba directed forward near the drive shaft 56, an extension portion 58bb in which the distal end of the bent portion 58ba is further bent in a direction away from the drive shaft 56, and a pressing unit 58bc in which the extension portion 58bb is further bent forward. The pressing unit 58bc has a surface slightly inclined with respect to the radial direction with reference to the drive shaft 56. As described above, since the lever portion 38 protrudes radially outward from the outer peripheral edge of the latch 24 and is thus close to the sector gear 58, the pressing lever 58b can be shortened accordingly, and the strength is also improved.

The deceleration mechanism 60 is a mechanism that decelerates the rotation of the motor 54 in two stages and transmits the decelerated rotation to the sector gear 58 and includes a first gear 60a and a second gear 60b. The first gear 60a meshes with the worm 54c and the second gear 60b, and the second gear 60b meshes with the first gear 60a and the teeth 58a. The lever opener 62 is provided on the left side and has a shape extending in the up-down direction and centered at a shaft 62a positioned at a substantially central height, has an open operation portion 62b formed at the lower end thereof and the emergency operation unit 62c formed at the upper end thereof, and is biased in a counterclockwise direction by a torsion spring 62d. The end of the emergency operation unit 62c is bent forward (see FIG. 2).

FIGS. 8A to 8D are diagrams illustrating the operation of the meshing unit 12 by the action of the pressing unit 58bc, in which FIG. 8A is a diagram illustrating a state before the striker S enters the holding notch 24a, FIG. 8B is a diagram illustrating a state in which the striker S has entered the holding notch 24a and entered a half latch state, FIG. 8C is a diagram illustrating a state in which the pressing unit 58bc starts to abut against the sliding contact surface 38a of the lever portion 38, and FIG. 8D is a diagram illustrating the full latch state. In FIGS. 8A to 8D, the top cover 20a is indicated by a virtual line.

As illustrated in FIG. 8A, in the state before the striker S enters the holding notch 24a, the holding notch 24a opens substantially forward, and the lever portion 38 is oriented substantially leftward. Furthermore, the pressing unit 58bc is located obliquely downward to the left with respect to the drive shaft 56 (see also FIG. 7A).

As illustrated in FIG. 8B, in the half latch state in which the striker S has entered the holding notch 24a, the latch 24 slightly rotates in the clockwise direction, and the engagement claw 28a of the ratchet 28 is engaged with the half latch engagement portion 24c to maintain the half latch state. In addition, at this point, an ECU detects the half latch state from a switch signal and drives the motor 54 to rotate the sector gear 58 in the counterclockwise direction. The lever portion 38 is directed obliquely rearward to the left, and the sliding contact surface 38a is positioned on a slightly left side of a vertical reference line V (see FIGS. 7A and 7B) passing through the drive shaft 56.

As illustrated in FIG. 8C, when the sector gear 58 rotates, the pressing unit 58bc comes into contact with the sliding contact surface 38a of the lever portion 38 and starts to press and drive the lever portion 38 in the right direction of the vehicle width while being in sliding contact with the sliding contact surface 38a.

As illustrated in FIGS. 8D and 7B, when the sector gear 58 further rotates, the opening direction of the holding notch 24a is oriented slightly obliquely rearward to the left, and the engagement claw 28a of the ratchet 28 is engaged with the full latch engagement portion 24b to maintain the full latch state. At this point, the ECU detects the full latch state from a switch signal and drives the motor 54 in the opposite direction to return the sector gear 58 to the position illustrated in FIG. 8A. Furthermore, the lever portion 38 is directed substantially rearward, and the sliding contact surface 38a is shifted slightly rightward from the vertical reference line V (see FIGS. 7A and 7B) passing through the drive shaft 56.

That is, the operation area for the pressing unit 58bc to press and to drive the lever portion 38 is set to an area below the drive shaft 56 and straddling the reference line V in the up-down direction passing through the drive shaft 56, and the displacement amount of the pressing unit 58bc in the vehicle up-down direction at the time of the close operation decreases, whereas the pressing unit 58bc is largely displaced in the vehicle width direction, whereby the area where the pressing unit 58bc is displaced in sliding contact with the sliding contact surface 38a of the lever portion 38 can be largely secured. In particular, since the sliding contact surface 38a protrudes from the outer periphery of the latch 24, some large displacement amount is required to rotate the latch 24 by a predetermined angle. However, the required displacement amount can be secured by such a structure in which the pressing unit 58bc straddles the reference line V. In addition, since the displacement amount in the vehicle up-down direction is reduced, the pressing unit 58bc to be in contact with the plate width of the lever latch 26 can be reduced.

As is clear from FIGS. 8A to 8D, at least a part of the lever portion 38 always overlaps the top cover 20a when viewed from a direction in the R direction. As a result, it is made possible to suppress inclination, deformation, or the like of the lever latch 26 at the time of retraction of the striker S. If the lever latch 26 is inclined, only the ridge 38b (see FIG. 5) abuts on the top cover 20a, and thus the contact area is suppressed with a small frictional resistance.

At the time of unlatching to release the latch, the sector gear 58 rotates in the clockwise direction under the action of the motor 54, and the pressing unit 58bc presses and drives the ratchet pole 28b of the ratchet 28 via the lever opener 62, whereby the engagement claw 28a is disengaged from the full latch engagement portion 24b. Operating the emergency operation unit 62c enables an unlatched state to be manually set even when the control of the motor 54 is disabled.

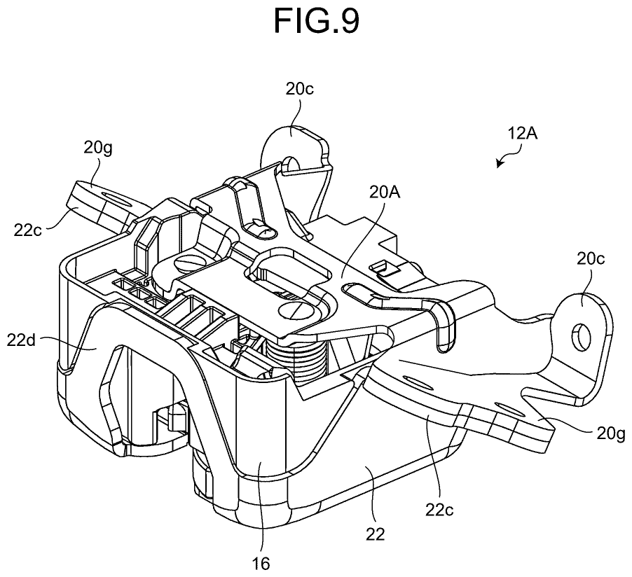

FIG. 9 is a perspective view of a meshing unit 12A according to a modification. A top plate 20A in the meshing unit 12A includes fixing pieces 20g on the left and right in addition to the fixing pieces 20c of the top plate 20 described above. The fixing pieces 20g has the same shape as those of the fixing pieces 22c of the bottom plate 22, overlap with the fixing pieces 22c, and have similar bolt holes formed therein. The top plate 20 including the top cover 20a and the bottom plate 22 including the bottom cover 22a are fastened together to the back door 102 by the fixing pieces 20g and 22c, whereby the fixing strength is improved.

In the door lock device 10 according to the present embodiment, the lever latch 26 is positioned on the R2 side with respect to the top cover 20a, and the pressing unit 58bc presses and drives the lever latch 26 on the R2 side with respect to the top cover 20a. That is, the operations of the lever latch 26 and the pressing unit 58bc are completed on the R2 side with respect to the top cover 20a, and, accordingly, the drive unit 14 can be disposed on the R2 side and a lower side, whereby the vertical dimension is suppressed, and further downsizing can be achieved.

Furthermore, in the lever portion 38 of the lever latch 26, the sliding contact surface 38a at the distal end protrudes radially outward from the outer peripheral edge of the latch 24, and the sliding contact surface 38a is pressed and driven in the vehicle width direction by the pressing unit 58bc at a position away from the latch shaft 30, whereby the driving force by the pressing unit 58bc can be reduced. Therefore, the power required for the motor 54 is suppressed, thereby allowing the motor 54 to be downsized and enabling further downsizing as a whole. The door lock device 10 is reduced in weight due to downsize, and is particularly suitable for a power back door. The present disclosure is applicable not only to the back door 102 but also to a side door, a sliding door, or the like of a vehicle.

It goes without saying that the present disclosure is not limited to the above-described embodiments but can be freely modified without departing from the gist of the disclosure.

According to a door lock device of the present disclosure, further downsizing can be achieved.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A door lock device provided to a door of a vehicle, the door lock device comprising:
a latch that engages with a striker of a body of the vehicle, the latch being rotatable about a latch axial direction orthogonal to an approach direction of the striker;
a top cover that supports a latch shaft serving as a rotation center of the latch on an upper side in the latch axial direction;
a lever latch integrally provided with the latch; and
a pressing unit that is driven by a motor and rotates about a drive shaft in the approach direction of the striker,
wherein the lever latch is positioned on a lower side with respect to the top cover in the latch axial direction, and
the pressing unit presses and drives the lever latch on a lower side with respect to the top cover in the latch axial direction.

2. The door lock device according to claim 1, further comprising:
a meshing unit including the latch, the lever latch, and a ratchet that holds the latch in an engagement state with the striker; and
a drive unit including the motor and a sector gear including the pressing unit, the sector gear being rotationally driven by the motor about the drive shaft,
wherein the drive unit and the meshing unit form an L shape or an obtuse L shape.

3. The door lock device according to claim 1, further comprising:
a ratchet that maintains an engagement state between the striker and the latch, the ratchet being rotatable about a ratchet shaft parallel to the latch shaft; and
a bottom cover that supports the latch shaft and the ratchet shaft on a lower side in the latch axial direction,
wherein the top cover supports the ratchet shaft on an upper side in the latch axial direction, and
the latch and the ratchet are disposed between the top cover and the bottom cover.

4. The door lock device according to claim 3,
wherein the top cover and the bottom cover are fastened together to the door.

5. The door lock device according to claim 3,
wherein the lever latch has a lever portion whose distal end protrudes radially outward from an outer peripheral edge of the latch when viewed in the latch axial direction, the distal end pressed and driven by the pressing unit, and
at least a part of the lever portion always overlaps the top cover when viewed in the latch axial direction.

6. The door lock device according to claim 1,
wherein an operation range for the pressing unit to press and drive the lever latch is set to an area extending across a reference line in an up-down direction passing through the drive shaft below the drive shaft.

7. The door lock device according to claim 2,
wherein the drive unit includes an emergency operation unit that releases engagement between the latch and the striker by a manual operation, the drive unit being covered with a resin housing except for the emergency operation unit.

8. A door lock device provided to a door of a vehicle, the door lock device comprising:
a latch that engages with a striker of a body of the vehicle, the latch being rotatable about a latch axial direction orthogonal to an approach direction of the striker, the latch having an engagement recess in the latch axial direction;
a lever latch integrally provided with the latch; and
a pressing unit that is driven by a motor and rotates about a drive shaft in the approach direction of the striker,
wherein the lever latch includes:
a lever portion whose distal end protrudes radially outward from an outer peripheral edge of the latch when viewed in the latch axial direction, the distal end being pressed and driven by the pressing unit;
an engagement protrusion being fitted into the engagement recess;
an annular portion to which the latch shaft is fitted; and
a column portion extending in the latch axial direction, the column portion connecting the engagement protrusion and the lever portion.

9. The door lock device according to claim 8,
wherein the engagement recess is a notch formed in the outer peripheral edge of the latch.

10. The door lock device according to claim 8,
wherein the latch and the lever latch are made of a metal material, and
a surface of the engagement recess on a side where the engagement protrusion applies a pressing force when the lever latch is pressed and driven from the pressing unit is exposed of the metal material, and
a surface of the engagement recess on an opposite side is covered with a resin material.

11. The door lock device according to claim 8,
wherein the lever portion extends along a plane orthogonal to the latch axial direction.
